(19) United States
(12) Patent Application Publication
(10) Pub. No.: US 2014/0053441 A1
(43) Pub. Date: Feb. 27, 2014

(54) SYSTEMS AND METHODS FOR BOLLARD COVER MEDIA ADVERTISING

(71) Applicant: AZA Sales LLC, Scottsdale, AZ (US)

(72) Inventors: William H. Arons, Phoenix, AZ (US); Jack E. Adams, Jr., Scottsdale, AZ (US); Jared D. Smith, Gilbert, AZ (US)

(73) Assignee: AZA Sales LLC, Scottsdale, AZ (US)

(21) Appl. No.: 14/010,260

(22) Filed: Aug. 26, 2013

Related U.S. Application Data
(60) Provisional application No. 61/692,878, filed on Aug. 24, 2012.

(51) Int. Cl. G09F 23/00

(52) U.S. Cl. CPC G09F 23/00
USPC 40/606.03

(57) ABSTRACT

Bollard covers and related advertising methods enable expanded media reach to consumers. Bollard covers are configured with changeable and/or replaceable media such as advertising. Via a flexible bollard cover, cylindrical bollards, U-shaped bollards, drive-through speaker boxes, and the like may be utilized to display advertising or other media.

### CROSS REFERENCE TO RELATED APPLICATIONS

This application claims priority to and is a non-provisional of U.S. Provisional No. 61/692,878 filed on Aug. 24, 2012 and entitled “SYSTEMS AND METHODS FOR BOLLARD COVER MEDIA ADVERTISING.” This provisional application is hereby incorporated by reference in its entirety.

### TECHNICAL FIELD

The present disclosure relates to media distribution and advertising, and in particular to use of bollard covers in connection with the same.

### BACKGROUND

Bollards are typically installed in areas having vehicular and/or pedestrian traffic, for example retail and drive-through locations. However, metal and/or concrete bollards are often unsightly; additionally, bollards have historically not been used to deliver advertising or other media. Accordingly, bollard covers and methods of using the same to present advertising and/or other media, particularly to consumers, are desirable.

### BRIEF DESCRIPTION OF THE DRAWINGS

With reference to the following description and accompanying drawings:

FIG. 1A illustrates exemplary cylindrical bollards of varied dimensions;

FIG. 1B illustrates a bollard covered by an exemplary bollard cover in accordance with an exemplary embodiment;

FIG. 2A illustrates exemplary cylindrical bollards of varied dimensions;

FIG. 2B illustrates a bollard covered by an exemplary bollard cover in accordance with an exemplary embodiment;

FIG. 2C illustrates the exemplary bollard cover of FIG. 2B in a top view;

FIG. 2D illustrates the exemplary bollard cover of FIG. 2B in a various additional views;

FIG. 3A illustrates an exemplary U-shaped bollard;

FIG. 3B illustrates a U-shaped bollard covered by an exemplary bollard cover in accordance with an exemplary embodiment;

FIG. 3C illustrates the exemplary bollard cover of FIG. 3B in various additional views;

FIG. 4A illustrates an exemplary drive-though ordering kiosk or speaker box;

FIG. 4B illustrates a drive-through ordering kiosk covered by an exemplary bollard cover in accordance with an exemplary embodiment;

FIG. 4C illustrates the exemplary bollard cover of FIG. 4B in a top view;

FIG. 4D illustrates the exemplary bollard cover of FIG. 4B in a perspective view; and

FIG. 5 illustrates a method for a bollard advertising program in accordance with an exemplary embodiment.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from principles of the present disclosure.

For the sake of brevity, conventional techniques for advertising, marketing, plastics fabrication, signage, and the like may not be described in detail herein. Furthermore, the connecting lines shown in various figures contained herein are intended to represent exemplary functional relationships and/or physical couplings between various elements. It should be noted that many alternative or additional functional relationships or physical connections may be present in an exemplary bollard cover and/or bollard cover advertising system. It will be appreciated that while the term “bollard cover” may be used herein, that the covers and principles of use thereof are broadly applicable, for example to drive-through speaker boxes, pillars, columns, posts, and/or the like.

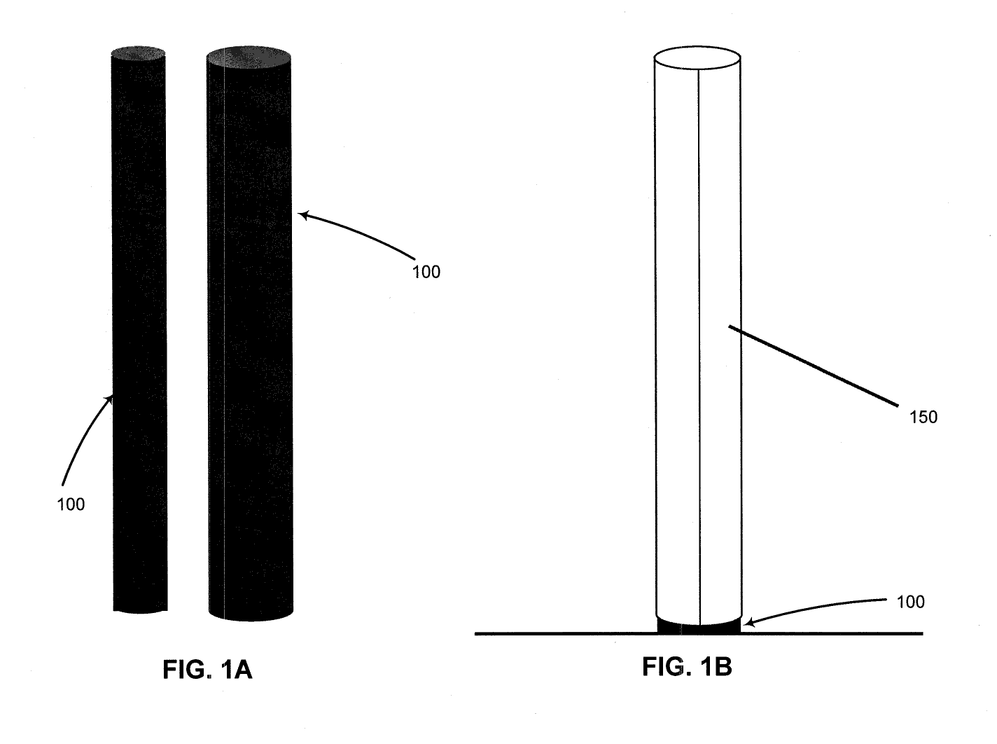

As typically used, “bollards” are concrete post and/or steel pipes that are available in standard and decorative shapes and sizes, for example as illustrated by bollards 100 in FIG. 1A. Bollards may be permanently or removably set in concrete or asphalt. Bollards may be located in desired locations, for example in parking lots on commercial properties, for collision prevention, to identify electrical equipment, direct vehicles to drive-thru windows, inform customers about ATM machines, to keep vehicles safe at gas station pumps, and so forth. Standard cylindrical bollards are usually approximately 4 to 11 inches wide and about 24 to 72 inches in length, and may be painted in a variety of solid opaque colors to fit their intended function. Concrete and/or steel bollards are often permanently installed and designated on properties that invite vehicular and pedestrian traffic onto their premises to sell retail products and promote consumer services.

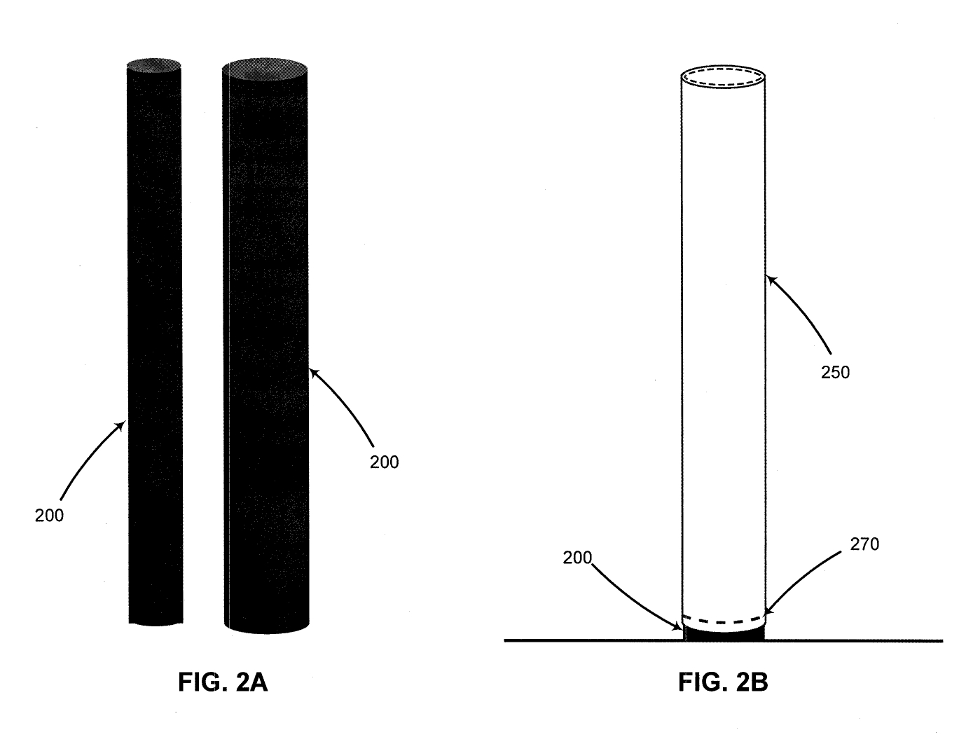

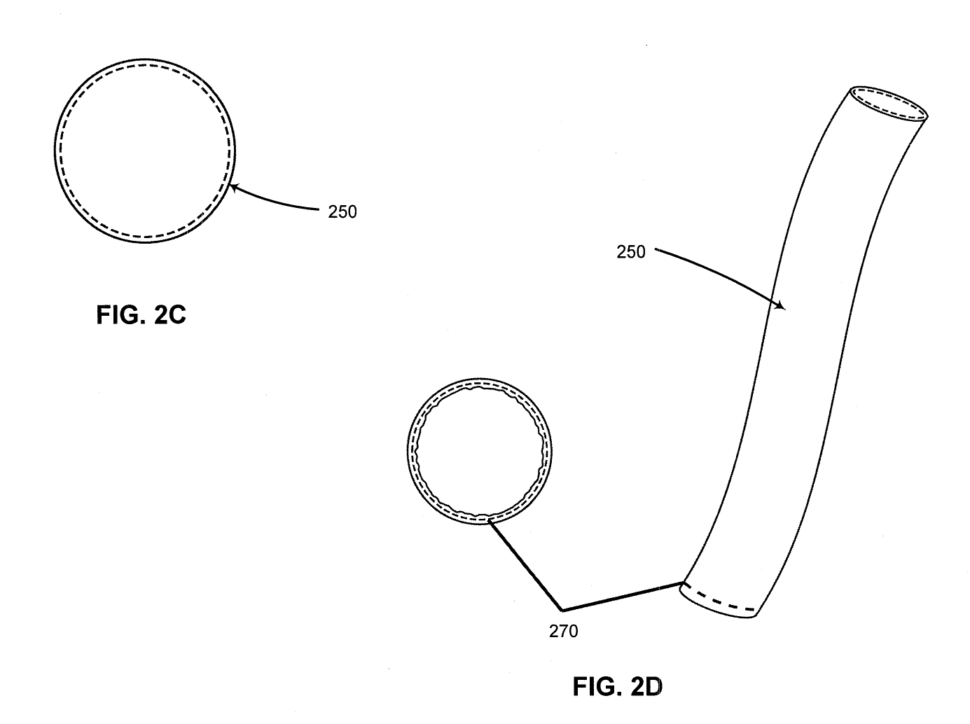

In addition to cylindrical bollards mounted vertically in the ground, bollards may also be structured as generally U-shaped (for example, as illustrated by bollard 200 in FIG. 2A), V-shaped, or otherwise having multiple points of contact with the ground.

In order to improve the durability and/or visibility of bollards, bollards are sometime painted, or covered with a sleeve or cover. Post sleeves or “bollard covers” may be fabricated from suitable materials, for example ⅛″ thick High Density Polyethylene (HDPE). They are often available in solid opaque colors and stock sizes. Bollard covers fit securely over installed concrete post or steel pipe bollards, and primarily function to minimize maintenance costs while protecting the concrete or steel bollards from deterioration due to exterior exposure and weather conditions. Bollard covers are often secured to the concrete and steel bollards with adhesive foam tape and/or mechanical fasteners.

While bollard covers tend to protect concrete post and/or steel bollards and minimize maintenance costs associated with atmospheric deterioration, plastic post sleeves are limited in functionality and utilization. Bollards are often located in highly trafficked areas; accordingly, utilization of bollards to deliver advertising, messaging, and other marketing and/or communicative purposes is desirable.

In accordance with principles of the present disclosure, with reference now to FIGS. 1A and 1B, in various exemplary embodiments the functionality and utilization of a bollard cover may be improved by applying and/or integrating advertising or other media to the bollard cover. For example, the exterior opaque colored face of the bollard cover may be covered with a surface applied, digitally printed, full color, pressure-sensitive vinyl (PSV) image, creating additional applications including but not limited to promotional advertising, public communication, corporate branding, visual displays, etc. on or about at ground level.

In accordance with principles of the present disclosure, in an exemplary embodiment a bollard cover 150 for advertising comprises a polyethylene plastic post sleeve in the standard opaque color and stock sizes and incorporates surface applied, digitally printed, full color PSV image using UV curable or solvent ink. The selected ink may be UV resistant in order to withstand environmental conditions. The PSV is then surface applied and wrapped to completely or partially cover bollard cover 150 and contours thus creating a three (3) dimensional graphic image on bollard cover 150, such that when bollard cover 150 is coupled to a concrete post or steel pipe bollard, the graphic design achieves maximum vehicular and pedestrian exposure and additional functionality including advertising, communication and branding using a bold, refreshing new medium.

In various exemplary embodiments, bollard cover 150 may be monolithic. In other exemplary embodiments, bollard cover 150 may comprise multiple layers, for example an inner structural layer such as HDPE, a middle graphic layer such as PSV, and optionally a clear outer protective layer such as a pressure sensitive vinyl laminate. In certain embodiments, the middle graphical layer and/or the outer protective layer may be removeable and/or replaceable, for example in order to facilitate changing and/or updating the graphical content as desired. Moreover, bollard cover 150 may be configured to partially and/or completely cover a bollard 100.

Bollard cover 150 may be generally cylindrical. In some embodiments, bollard cover 150 has a flat top; in other embodiments, bollard cover 150 has a rounded and/or hemispherical top.

Bollard covers 150 configured in accordance with principles of the present disclosure may be fabricated from any suitable durable materials, for example plastics. Moreover, images may be directly fabricated on or in bollard cover 150; alternatively, bollard cover 150 may be coupled to a graphic wrap or other suitable medium for presenting media as discussed above. In various exemplary embodiments, bollard cover 150 may be coupled to and/or comprise a polystyrene body.

Media and/or advertising on bollard cover 150 may be changed from time to time, for example to feature new products and/or services, such as by removing bollard cover 150 from a concrete or steel bollard 100 and reapplying new graphics.

With reference now to FIGS. 2A through 2D, in certain exemplary embodiments a bollard cover 250 may be formed from a flexible and/or stretchable material, for example a textile. In an exemplary embodiment, a bollard cover 250 comprises a stretchable material, for example elastane, Polartec® brand Power Stretch® fabrics, KI brand Soft Knit fabrics, a polyester textile and/or polyester-coated textile, and/or the like. Bollard cover 250 may be generally cylindrical with a flat stitched top; moreover, bollard cover 250 may be configured with any suitable dimensions or portions to facilitate at least partially covering a bollard 200.

Bollard cover 250 may be decorated, labeled, printed, marked, and/or otherwise configured with advertising, marketing, media, or other information or symbols via any suitable process or method, for example via dye sublimation (digital print) process (paper transfer or direct to fabric). Bollard cover 250 may also be painted, stenciled, dyed, or otherwise marked, colored, and/or decorated, as desired.

In various exemplary embodiments, bollard cover 250 may comprise a flexible cinch and/or drawstring 270 to facilitate retention on bollard 200. Drawstring 270 may be releasable to facilitate removal or bollard cover 250 from bollard 200. In an exemplary embodiment, drawstring 270 comprises a polyester drawstring of about ⅛″ thickness, and bollard cover 250 is sewn and/or structured to fit bollard 200. In another exemplary embodiment, drawstring 270 comprises an elastic band of about ¼″ thickness, and bollard cover 250 is sewn and/or structured to fit bollard 200. Moreover, bollard cover 250 may be releasably coupled to bollard 200 via any suitable materials, structures, and/or approaches.

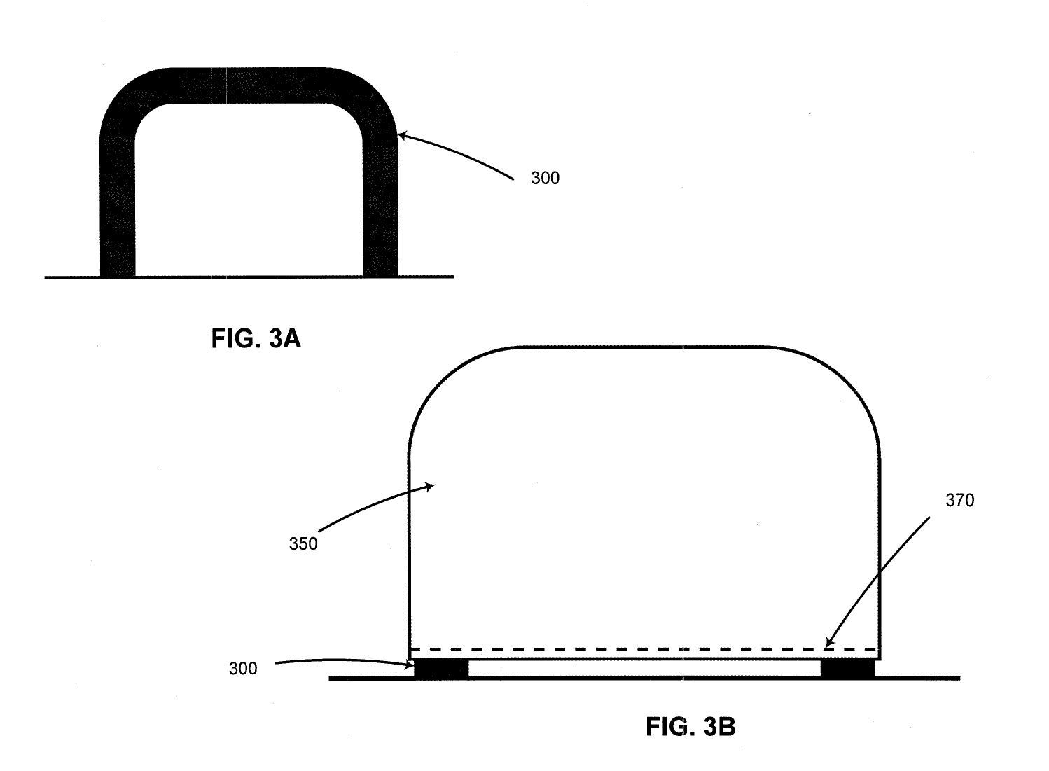

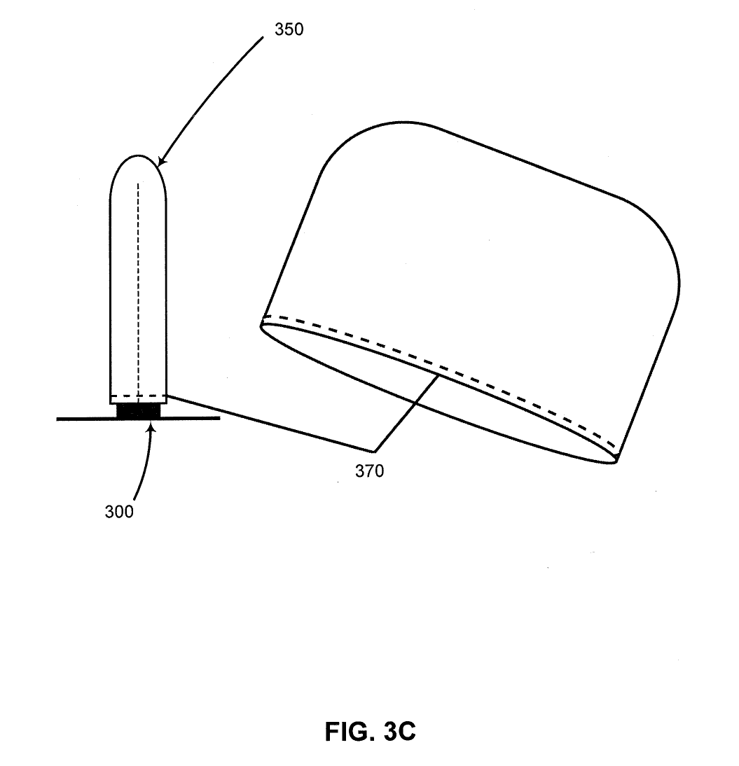

Turning now to FIGS. 3A through 3C, in accordance with principles of the present disclosure, a bollard cover may be utilized in connection with bollards and/or other objects that have a form factor other than an upright cylinder. In various exemplary embodiments, a bollard cover 350 may be utilized in connection with a U-shaped bollard 300. Bollard cover 350 may comprise a material or materials similar to bollard cover 250 discussed hereinabove; moreover, bollard cover 350 may be configured with a flexible cinch and/or drawstring 370 to facilitate retention on bollard 300. Drawstring 370 may be configured and utilized in a manner similar to drawstring 270 discussed hereinabove.

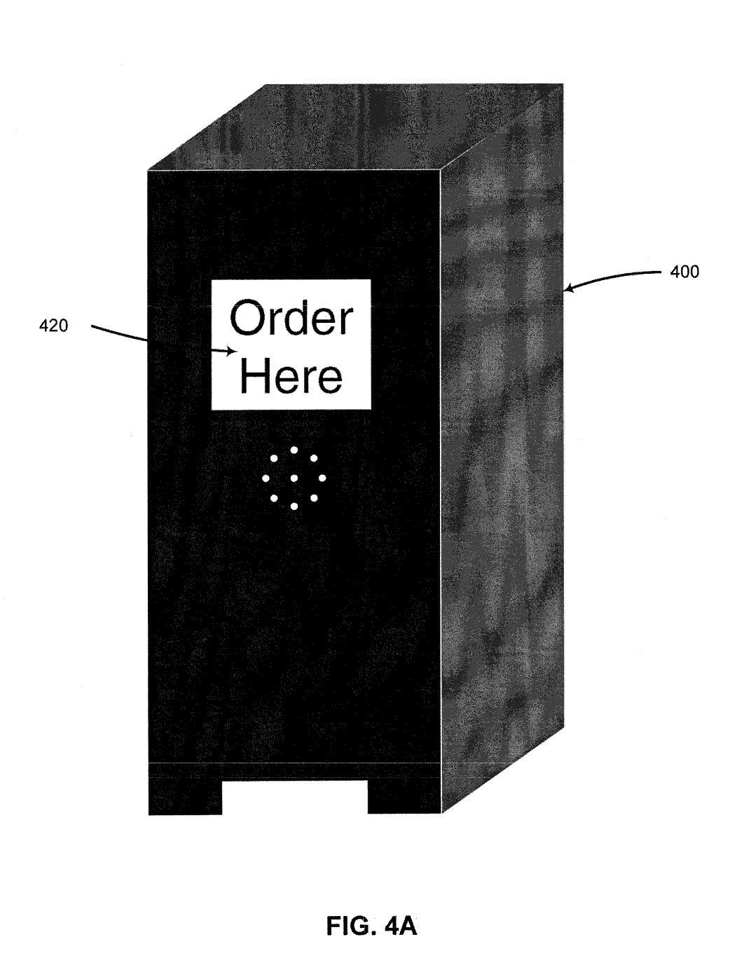

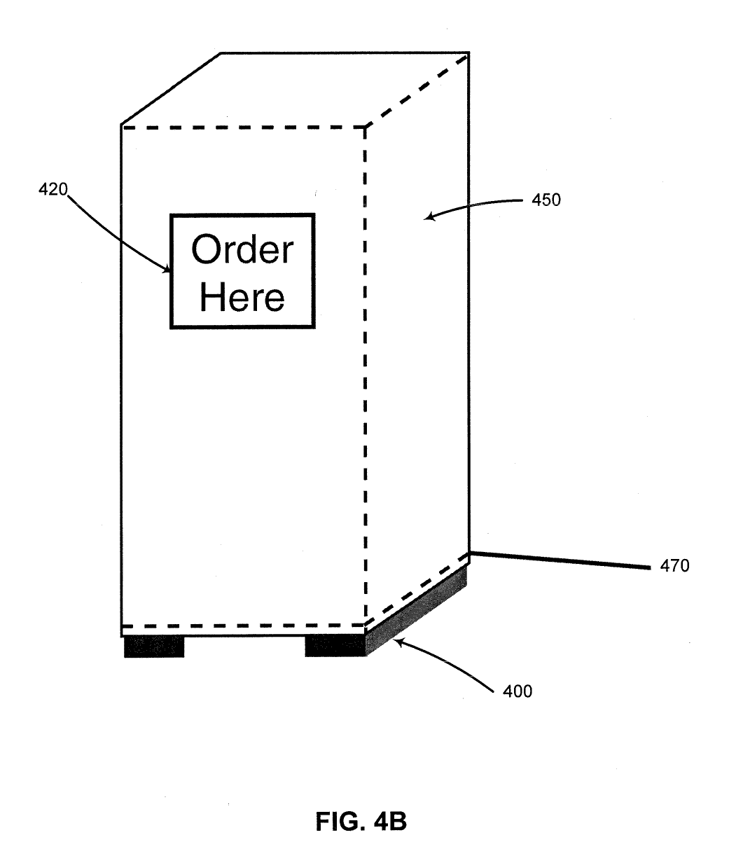

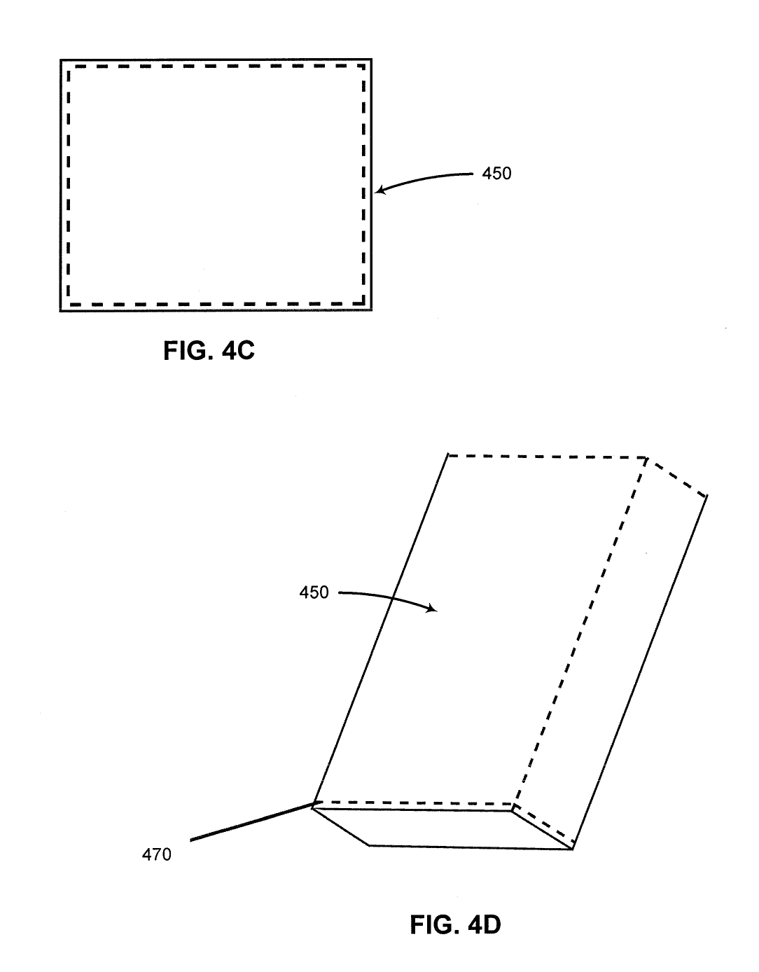

With reference now to FIGS. 4A through 4D, in accordance with principles of the present disclosure, a bollard cover may be utilized in connection with a drive-through speaker box or ordering kiosk, for example as commonly utilized at a fast-food restaurant. In certain exemplary embodiments, bollard cover 450 is configured to fit over and/or at least partially conceal a drive-through speaker box 400 having a screen or speaker 420. Bollard cover 450 may comprise similar materials to bollard cover 250 and/or 350; moreover, bollard cover 450 may be configured with an opening or aperture in order to avoid obscuring screen/speaker 420. Bollard cover 450 may be configured with a flexible cinch and/or drawstring 470 to facilitate retention on speaker box 400. Drawstring 470 may be configured and utilized in a manner similar to drawstring 270 and/or 370 discussed hereinabove. Bollard cover 450 may be configured with permanent and/or changeable advertising, graphics, and/or other media as discussed herein.

By utilizing bollard covers configured in accordance with principles of the present disclosure, an improved means to advertise and communicate with retail, institutional and industrial customers is achieved. Additionally, bollard covers configured in accordance with principles of the present disclosure provide protection to vehicles from the hard concrete post and/or the steel pipe surfaces by reducing vehicle scratches and dents due to accidental contact.

By utilizing bollard covers configured in accordance with principles of the present disclosure, underutilized space in business parking and pedestrian areas may be captured, enhanced, and leveraged into eye-catching, appealing branding and/or advertising locations.

In certain exemplary embodiments, a plurality of bollard covers (for example, bollard covers 150, 250 and/or 350) may be disposed over bollards that are located close to one another. Each of the bollard covers may be configured with a portion of graphical content, such that an overall image may appear to be distributed across multiple bollard covers. In other exemplary embodiments, a plurality of bollard covers may be placed over a series of bollards in a cascading fashion, such that when a pedestrian passes by the series of bollards, the pedestrian is exposed to a sequential message or other marketing content distributed across the bollard covers.

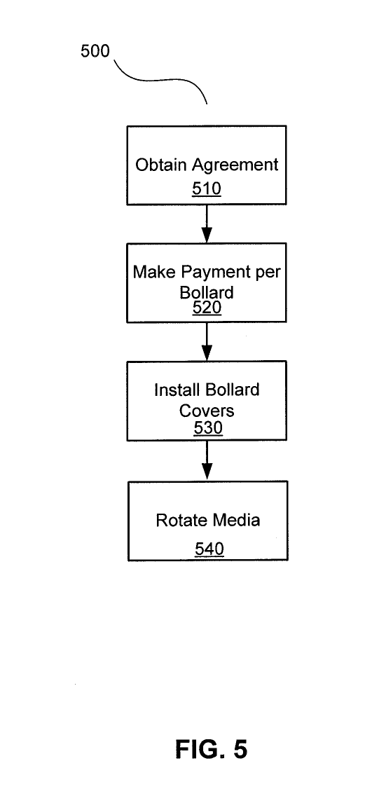

In various exemplary embodiments, with reference now to FIG. 5, a bollard advertising program (BAP) utilizing bollard covers configured in accordance with principles of the present disclosure allows an expanded medium for advertising agencies and business owners. An exemplary BAP 500 targeted at convenience stores/gas stations may include (i) obtaining lease agreements (for example, about 1 year to about 5 year agreements) for the bollard areas (step 510), and (ii) paying the convenience store/gas station an amount of money on a quantity basis to use the bollard space (step 520), creating a no-cost immediate revenue source for the business. Bollard covers configured with advertising or other media are installed on the bollard (step 530). The advertising on the bollards may be rotated (step 540), for example on a scheduled basis, according to the requests of a national brand, according to the requests of the convenience store, and so forth.

Bollard covers and BAPs may be utilized for various industries and/or locations, for example universities, hospitals, fast food locations drive through lanes, chains, convenience stores, gas stations, parking structures, concert or event venues, check cashing, sports arenas, movie theaters, automotive service companies, utility companies, banks, pharmacies, entrances to retail store fronts, inside retail locations, traffic way finding, and/or the like.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection.

When language similar to “at least one of A, B, or C” or “at least one of A, B, and C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A bollard cover for advertising, comprising:
a plastic bollard cover body; and
an advertising wrap applied to the bollard cover body, wherein the bollard cover is disposed over a bollard.

2. The bollard cover of claim 1, wherein the advertising wrap comprises a digitally printed graphic.

3. The bollard cover of claim 1, wherein the advertising wrap is replaceable to update the advertising on the bollard cover.

4. The bollard cover of claim 1, wherein the advertising wrap comprises a PSV graphic.

5. A bollard cover for a bollard, comprising:
a stretchable body configured with media printed thereon; and
a retention mechanism configured to couple the bollard cover to the bollard.

6. The bollard cover of claim 5, wherein the bollard is U-shaped.

7. The bollard cover of claim 5, wherein the stretchable body comprises a dye sublimated stretchable textile.

8. The bollard cover of claim 5, wherein the stretchable body is configured with U-shaped pipe guards.

9. The bollard cover of claim 5, wherein the retention mechanism comprises an elastic band.

10. The bollard cover of claim 5, wherein the retention mechanism comprises a drawstring.

11. The bollard cover of claim 5, wherein the stretchable body is configured to align with the shape of the U-shaped bollard.

12. A bollard cover for a drive-through speaker box, comprising:
a stretchable body configured with media printed thereon, the stretchable body having an aperture configured to expose a display area of the speaker box; and
a retention mechanism configured to couple the bollard cover to the drive-through speaker box.

13. The bollard cover of claim 12, wherein the stretchable body comprises a dye sublimated stretchable textile.

14. The bollard cover of claim 12, wherein the retention mechanism comprises an elastic band.

15. The bollard cover of claim 12, wherein the retention mechanism comprises a drawstring.

16. A method of using a bollard cover to present advertising, the method comprising:
digitally printing selected advertising content on PSV;
applying the PSV to a plastic bollard cover; and
placing the bollard cover over a bollard to conceal the bollard and present the advertising.

17. The method of claim 16, further comprising updating the advertising content by
applying a new PSV to the bollard cover.

18. A method of using a bollard cover to present media, the method comprising:
forming a bollard cover configured to cover a U-shaped bollard, the bollard cover configured with a stretchable body with the media printed thereon;
placing the bollard cover over the U-shaped bollard to conceal the U-shaped bollard and present the media; and
coupling the bollard cover to the U-shaped bollard via at least one of an elastic band, a drawstring, and a compressive force generated via distortion of the stretchable body.
